(19) United States
(12) Patent Application Publication
(10) Pub. No.: US 2014/0319817 A1
(43) Pub. Date: Oct. 30, 2014

(54) SECURITY DOCUMENT AND METHOD OF MANUFACTURING SECURITY DOCUMENT

(71) Applicant: Jarmo Nikkila, Meudon (FR)

(72) Inventor: Jarmo Nikkila, Meudon (FR)

(73) Assignee: GEMALTO SA, Meudon (FR)

(21) Appl. No.: 14/362,389

(22) PCT Filed: Nov. 30, 2012
(86) PCT No.: PCT/EP2012/074164

§ 371 Date: Jun. 2, 2014

(30) Foreign Application Priority Data
Dec. 2, 2011 (EP) 11306603.9

(51) Int. Cl. B42D 15/00; B41M 3/14

(52) U.S. Cl. CPC B42D 15/0013; B41M 3/144; B42D 2031/04
USPC 283/85; 101/211

(57) ABSTRACT

A security document having a first side (11) and a second side (12), the security document comprising a first pattern (31) and a second pattern (32) located closer to the second side (12) than the first pattern (31), the first pattern (31) and the second pattern (32) overlapping such that the overlapping area defines a shape of a security pattern (40).The first pattern (31) comprises first single fluorescent substance adapted to emit first visible light (61), and the second pattern (32) comprises second single fluorescent substance adapted to emit second visible light (62).When the security pattern (40) is irradiated from the direction of the first side (11) the first visible light (61) dominates the second visible light (62) at the first excitation radiation (51) and the second visible light (62) dominates the first visible light (61) at the second excitation radiation (52).

### FIELD OF THE INVENTION

The present invention relates to a security document such as an identity card or driving licence, for instance. The invention further relates to a method of manufacturing the security document.

### BACKGROUND OF THE INVENTION

It is known in the art to provide a security document with a security pattern that fluoresce one colour when excited by a first excitation radiation and another colour when excited by a second excitation radiation. Both the first excitation radiation and the second excitation radiation are ultraviolet light. Such a known security pattern comprises a bi-fluorescent ink. Bi-fluorescent inks are expensive materials.

### BRIEF DESCRIPTION OF THE INVENTION

An object of the present invention is to provide a security document which is at least as difficult to forger as the above described known security document but does not require use of any bi-fluorescent ink. The object of the invention is achieved by a security document which is characterized by what is stated in the independent claim 1. The preferred embodiments of the security document are disclosed in the dependent claims.

A further object of the present invention is to provide a method of manufacturing the security document. The further object of the invention is achieved by a method which is characterized by what is stated in the independent method claim.

The invention is based on the idea of providing a security document with a first pattern and a second pattern each comprising a single fluorescent substance, the first pattern and the second pattern overlapping such that the overlapping area defines a shape of a security pattern which emits different visible light depending on frequency of excitation radiation. In other words the present invention provides a bi-fluorescent effect with single fluorescent substances.

An advantage of the security document of the invention is that the colour changing effect of the security pattern is achieved with inexpensive single fluorescent substances.

### BRIEF DESCRIPTION OF THE DRAWINGS

In the following the invention will be described in greater detail by means of preferred embodiments with reference to the attached drawings, in which

FIG. 1 shows a security document according to an embodiment of the invention from a direction of a first side;

FIG. 2 shows the security document of FIG. 1 from a direction of a second side;

FIG. 3 shows irradiation of a security pattern of the security document with a first excitation radiation from the direction of the first side;

FIG. 4 shows irradiation of the security pattern of the security document with a second excitation radiation from the direction of the first side;

FIG. 5 shows irradiation of the security pattern of the security document with the first excitation radiation from the direction of the second side; and

FIG. 6 shows irradiation of the security pattern of the security document with the second excitation radiation from the direction of the second side.

### DETAILED DESCRIPTION OF THE INVENTION

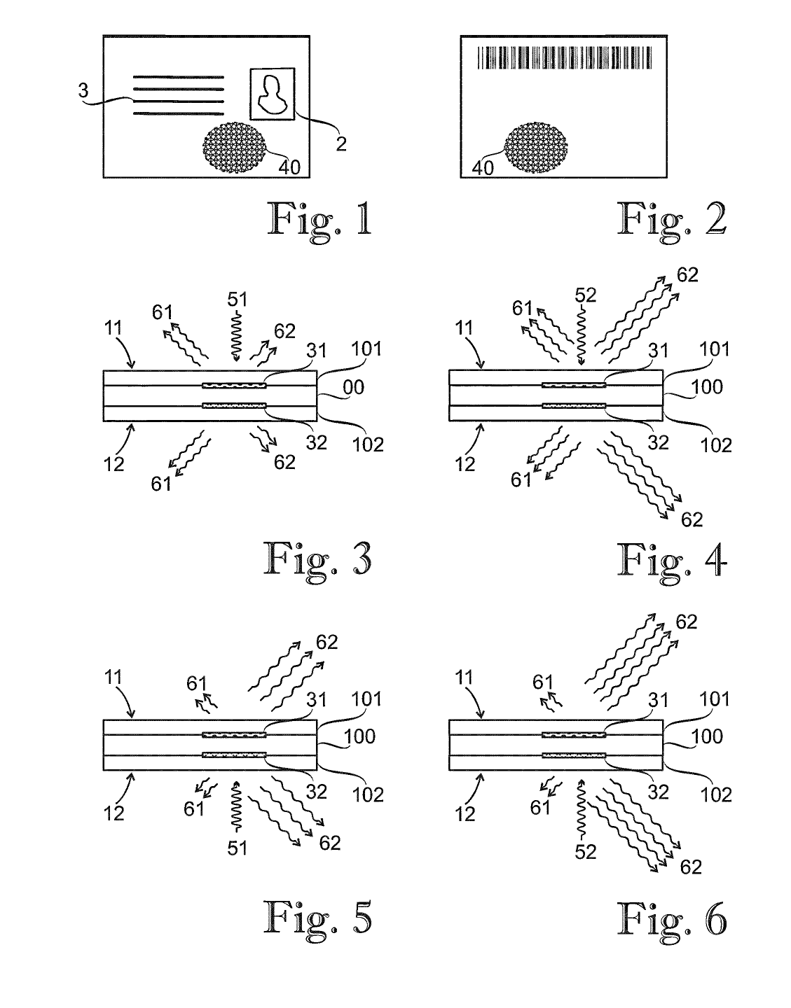

FIG. 1 shows a security document comprising a photograph 2 of the holder, written data 3 with information about the holder, and a security pattern 40, which is embedded into the material of the security document. The security pattern 40 may be substantially invisible in daylight.

In FIG. 1 the security document is seen from a direction of a first side of the security document. In FIG. 2 the security document is seen from a direction of a second side of the security document, the second side facing an opposite direction with relation to the first side.

FIGS. 3 to 6 show irradiation of the security pattern of the security document of FIG. 1 with a first excitation radiation 51 and a second excitation radiation 52 from the direction of the first side 11 and the second side 12.

In FIGS. 3 to 6 the security document is depicted as a sectional view as seen from a direction parallel to the plane of the security document.

FIGS. 3 to 6 show that the security document comprises a base layer 100, a first pattern 31, a second pattern 32, a first cover layer 101 and a second cover layer 102. The first cover layer 101 is the outermost layer of the security document on the first side 11. The second cover layer 102 is the outermost layer of the security document on the second side 12. The first pattern 31 is located between the base layer 100 and the first cover layer 101. The second pattern 32 is located between the base layer 100 and the second cover layer 102. Therefore the second pattern 32 is located closer to the second side 12 than the first pattern 31. The first pattern 31 and the second pattern 32 overlap such that the overlapping area defines a shape of the security pattern 40.

The first pattern 31 comprises first single fluorescent substance adapted to emit first visible light 61. The second pattern 32 comprises second single fluorescent substance adapted to emit second visible light 62, the second visible light been different from the first visible light 61. In this embodiment the first visible light 61 is red, and the second visible light 62 is blue.

FIG. 7 shows the excitation spectra of the first pattern 31 and the second pattern 32. In the embodiment shown in FIG. 7 the frequency of the first excitation radiation 51 is 302 nm and the frequency of the second excitation radiation 52 is 365 nm. Those frequencies are widely used in the field of document authentication. Both the first pattern 31 and the second pattern 32 have an excitation spectrum which has a substantially lower value at a frequency of the first excitation radiation 51 than at a frequency of the second excitation radiation 52. The excitation spectrum of the second pattern 32 has a substantially higher value than the excitation spectrum of the first pattern 31 at the frequency of the second excitation radiation 52. At the frequency of the first excitation radiation 51 the value of the excitation spectrum of the first pattern 31 is substantially the same as the value of the excitation spectrum of the second pattern 32. Further, at the frequency of the first excitation radiation 51 the values of both the excitation spectrum of the first pattern 31 and the excitation spectrum of the second pattern 32 are substantially smaller than the value of the excitation spectrum of the first pattern 31 at the frequency of the second excitation radiation 52.

An appropriate shape of an excitation spectrum is achieved by selecting a suitable single fluorescent substance. A height of the excitation spectrum may be adjusted by changing a concentration of the single fluorescent substance in a colouring agent forming a corresponding pattern. For example, it is possible to use a second single fluorescent substance whose excitation spectrum is lower than an excitation spectrum of the first single fluorescent substance by lowering sufficiently a concentration of the first single fluorescent substance in a colouring agent forming a first pattern. In other words, a height of an excitation spectrum depends on both characteristics of the single fluorescent substance used and the concentration of the single fluorescent substance in a colouring agent forming a corresponding pattern.

Each single fluorescent substance may comprise a chemical agent or a chemical compound or a mixture of chemical compounds. Each colouring agent comprising single fluorescent substance may further comprise various binding agents and/or intermediate agents.

The security pattern 40 has a first transmittivity coefficient I-I for the first side 11 and the first excitation radiation 51. The first transmittivity coefficient I-I expresses the portion of the first excitation radiation 51 that reaches the second pattern 32 relative to the intensity of the first excitation radiation 51 that reaches the first pattern 31 when the first excitation radiation 51 is irradiated from the direction of the first side 11.

The security pattern 40 also has a second transmittivity coefficient I-II for the first side 11 and the second excitation radiation 52. The second transmittivity coefficient I-II expresses the portion of the second excitation radiation 52 that reaches the second pattern 32 relative to the intensity of the second excitation radiation 52 that reaches the first pattern 31 when the second excitation radiation 52 is irradiated from the direction of the first side 11.

The security pattern 40 further has a third transmittivity coefficient II-I for the second side 12 and the first excitation radiation 51. The third transmittivity coefficient II-I expresses the portion of the first excitation radiation 51 that reaches the first pattern 31 relative to the intensity of the first excitation radiation 51 that reaches the second pattern 32 when the first excitation radiation 51 is irradiated from the direction of the second side 12.

The first transmittivity coefficient I-I and the second transmittivity co-efficient I-II have been selected in such a relation to the values of the excitation spectra of the first pattern 31 and the second pattern 32 that when the security pattern 40 is irradiated from the direction of the first side 11 the first visible light 61 dominates the second visible light 62 at the first excitation radiation 51 and the second visible light 62 dominates the first visible light 61 at the second excitation radiation 52. This effect is discussed below in connection with an exemplary embodiment with reference to FIGS. 3 and 4.

In FIG. 3 the security pattern 40 of the security document is irradiated with the first excitation radiation 51 from the direction of the first side 11 such that a certain intensity of the first excitation radiation 51 reaches the first pattern 31. In response to the first excitation radiation 51 the first pattern 31 emits the first visible light 61 with certain intensity. A portion of the first excitation radiation 51 passes through the first pattern 31 and reaches the second pattern 32. In response to the remaining intensity of the first excitation radiation 51 the second pattern 32 emits the second visible light 62 with certain intensity. The intensity of the first visible light 61 is substantially higher than the intensity of the second visible light 62 and therefore the first visible light 61 dominates the second visible light 62. This means that a viewer sees the security pattern 40 as a red pattern.

The first transmittivity coefficient I-I expresses the relation between the intensity of the first excitation radiation 51 reaching the second pattern 32 and the intensity of the first excitation radiation 51 reaching the first pattern 31. For example, if the first transmittivity coefficient I-I is 50% or 0,5 the intensity of the first excitation radiation 51 reaching the second pattern 32 is half of the intensity of the first excitation radiation 51 reaching the first pattern 31. An appropriate, i.e. low enough first transmittivity coefficient I-I is necessary in order to ascertain that a viewer sees the security pattern 40 as a red pattern. For example, if the first transmittivity coefficient I-I would be 95% the second pattern 32 would receive almost the same amount of the first excitation radiation 51 as the first pattern 31, and consequently the blue light emitted by the second pattern 32 would have almost the same intensity as the red light emitted by the first pattern 31. Therefore the viewer would see the security pattern 40 as a purple pattern.

In FIG. 4 the security pattern 40 of the security document is irradiated with the second excitation radiation 52 from the direction of the first side 11 such that a certain intensity of the second excitation radiation 52 reaches the first pattern 31. In response to the second excitation radiation 52 the first pattern 31 emits the first visible light 61 with certain intensity. If the intensity of the second excitation radiation 52 reaching the first pattern 31 would be the same as the intensity of the first excitation radiation 51 reaching the first pattern 31 in FIG. 3 the intensity of the emitted red light would be substantially higher than in situation of FIG. 3 because the excitation spectrum of the first pattern 31 is substantially higher at the frequency of the second excitation radiation 52 than at the frequency of the first excitation radiation 51.

A portion of the second excitation radiation 52 passes through the first pattern 31 and reaches the second pattern 32. In response to the remaining intensity of the second excitation radiation 52 the second pattern 32 emits the second visible light 62 with certain intensity. The intensity of the second visible light 62 is substantially higher than the intensity of the first visible light 61 and therefore the second visible light 62 dominates the first visible light 61. Therefore a viewer sees the security pattern 40 as a blue pattern.

In the situation of FIG. 4 the second visible light 62 dominates due to the fact that at the frequency of the second excitation radiation 52 the excitation spectrum of the second pattern 32 has a substantially higher value than the excitation spectrum of the first pattern 31. It should be understood that in order to achieve the blue colour dominance the second transmittivity coefficient I-II must be appropriate. For example, if the second transmittivity coefficient I-II would be 5%, the value of the excitation spectrum of the second pattern 32 would have to be approximately fifty times the value of the excitation spectrum of the first pattern 31 at the second excitation radiation 52 to ascertain dominance of the blue colour. The higher the second transmittivity coefficient I-II is the smaller difference is required in the values of the excitation spectra of the first pattern 31 and the second pattern 32 at the frequency of the second excitation radiation 52.

In FIG. 5 the security pattern 40 of the security document is irradiated with the first excitation radiation 51 from the direction of the second side 12 such that a certain intensity of the first excitation radiation 51 reaches the second pattern 32. In response to the first excitation radiation 51 the second pattern 32 emits the second visible light 62 with certain intensity.

A portion of the first excitation radiation 51 passes through the second pattern 32 and reaches the first pattern 31. In response to the remaining intensity of the first excitation radiation 51 the first pattern 31 emits the first visible light 61 with certain intensity. The intensity of the second visible light 62 is substantially higher than the intensity of the first visible light 61 and therefore the second visible light 62 dominates the first visible light 61. This means that a viewer sees the security pattern 40 as a blue pattern.

Since at the frequency of the first excitation radiation 51 the value of the excitation spectrum of the first pattern 31 is substantially the same as the value of the excitation spectrum of the second pattern 32 the third transmittivity coefficient II-I must be low enough. For example, if the third transmittivity coefficient II-I would be 95% the first pattern 31 would receive almost the same amount of the first excitation radiation 51 as the second pattern 32, and consequently the red light emitted by the first pattern 31 would have almost the same intensity as the blue light emitted by the second pattern 32. Therefore the viewer would see the security pattern 40 as a purple pattern.

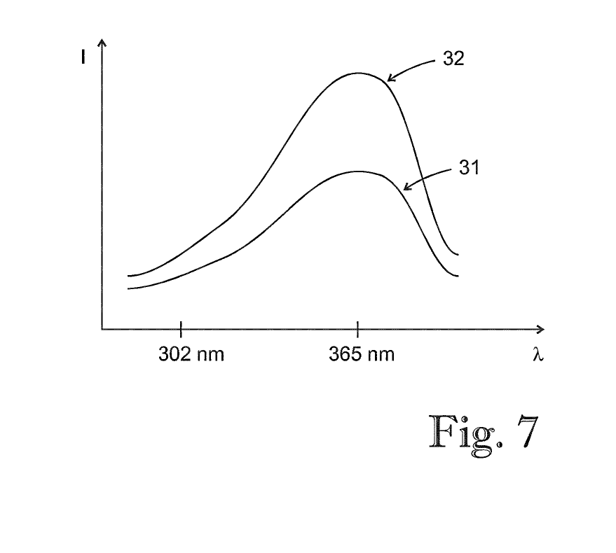

In FIG. 6 the security pattern 40 of the security document is irradiated with the second excitation radiation 52 from the direction of the second side 12 such that a certain intensity of the second excitation radiation 52 reaches the second pattern 32. In response to the second excitation radiation 52 the second pattern 32 emits the second visible light 62 with certain intensity. A portion of the second excitation radiation 52 passes through the second pattern 32 and reaches the first pattern 31. In response to the remaining intensity of the second excitation radiation 52 the first pattern 31 emits the first visible light 61 with certain intensity. The intensity of the second visible light 62 is substantially higher than the intensity of the first visible light 61 and therefore the second visible light 62 dominates the first visible light 61. A viewer sees the security pattern 40 as a blue pattern.

In the situation of FIG. 6 the second visible light 62 dominates due to two facts. Firstly it is self-explanatory that the intensity of the second excitation radiation 52 reaching the first pattern 31 is lower than the intensity of the second excitation radiation 52 reaching the second pattern 32. Secondly the excitation spectrum of the second pattern 32 has a substantially higher value than the excitation spectrum of the first pattern 31 at the frequency of the second excitation radiation 52. Thus the viewer newer sees the security pattern 40 as a red pattern regardless of how big portion of the second excitation radiation 52 reaches the first pattern.

A method of checking authenticity of the security document according to FIG. 1 comprises steps of irradiating the security pattern 40 from the direction of the first side 11 with both the first excitation radiation 51 and the second excitation radiation 52. The first excitation radiation 51 should induce a red colour and the second excitation radiation 52 should induce a blue colour. Otherwise the security document under examination is deemed as a forgery.

The method of checking authenticity of the security document may further comprise steps of irradiating the security pattern 40 from the direction of the second side 12 with both the first excitation radiation 51 and the second excitation radiation 52. Both the first excitation radiation 51 and the second excitation radiation 52 should induce a blue colour. Otherwise the security document under examination is deemed as a forgery.

Above has been disclosed that in the situation of FIG. 3 a viewer sees the security pattern 40 as a red pattern, and in the situations of FIGS. 4, 5 and 6 a viewer sees the security pattern 40 as a blue pattern. It is clear that the shade of blue may be different in situations of FIGS. 4, 5 and 6. However, a human eye interprets the security pattern as a blue pattern.

In an embodiment each one of the base layer 100, the first cover layer 101 and the second cover layer 102 is substantially transparent with respect to the first excitation radiation 51 and the second excitation radiation 52.

Further, each one of the base layer 100, the first cover layer 101 and the second cover layer 102 may be substantially transparent with respect to the first visible light 61 and the second visible light 62. If the entire security pattern 40 is substantially transparent with respect to the first visible light 61 and the second visible light 62 then the security pattern emits during excitation substantially same shade of visible light both from the first side and from the second side.

In the embodiment shown in FIGS. 3 to 6 the first pattern 31 and the second pattern 32 are provided on different sides of the base layer 100. In an alternative embodiment the first pattern and the second pattern are provided on the same side of the base layer such that the second pattern is located directly on the first pattern.

The first cover layer 101 is adapted to protect the first pattern 31 and the second cover layer 102 is adapted to protect the second pattern 32. In embodiments where the first pattern and the second pattern are made of wear-resistant materials the first cover layer and the second cover layer are not compulsory. In an alternative embodiment the security pattern comprises no base layer but only the first pattern and the second pattern fixed to each other.

In an embodiment the security pattern is adapted to be irradiated exclusively from the direction of the first side of the security document. In such an embodiment the security document may comprise a blocking layer located closer to the second side than the first pattern and the second pattern, the blocking layer being opaque with respect to the first excitation radiation and the second excitation radiation.

In security documents adapted to be irradiated exclusively from the direction of the first side the value of the excitation spectrum of the first pattern may be higher than the value of the excitation spectrum of the second pattern at the frequency of the first excitation radiation. This is also possible in security documents adapted to be irradiated both from the direction of the first side and from the direction of the second side but it naturally requires lowering the third transmittivity coefficient as can be seen from FIG. 5.

The first pattern and/or second pattern may be laser engraved. By removing an area of the first pattern or the second pattern a corresponding area of the other pattern is exposed through the laser engraved area. For example, by laser engraving a security text in the first pattern the security text emits the second visible light both with the first excitation radiation and the second excitation radiation. The laser engraving further hinders forgery of the security document.

It will be obvious to a person skilled in the art that the inventive concept can be implemented in various ways. The invention and its embodiments are not limited to the examples described above but may vary within the scope of the claims.

1. A security document having a first side and a second side, the security document comprising: a first pattern and a second pattern located closer to the second side than the first pattern, the first pattern and the second pattern overlapping such that the overlapping area defines a shape of a security pattern , the security pattern being adapted to be irradiated with an excitation radiation from at least direction of the first side, wherein the first pattern comprises first single fluorescent substance adapted to emit first visible light, and the second pattern comprises second single fluorescent substance adapted to emit second visible light, both the first pattern and the second pattern having an excitation spectrum which has a substantially lower value at a frequency of a first excitation radiation than at a frequency of a second excitation radiation, the excitation spectrum of the second pattern having a substantially higher value than the excitation spectrum of the first pattern at the frequency of the second excitation radiation the security pattern having a first transmittivity coefficient for the first side and the first excitation radiation, and a second transmittivity coefficient for the first side and the second excitation radiation selected in such a relation to the values of the excitation spectra of the first pattern and the second pattern that when the security pattern is irradiated from the direction of the first side the first visible light dominates the second visible light at the first excitation radiation and the second visible light dominates the first visible light at the second excitation radiation.

2. A security document according to claim 1, wherein at the frequency of the first excitation radiation a difference between a value of the excitation spectrum of the first pattern and a value of the excitation spectrum of the second pattern is substantially smaller than the difference between a value of the excitation spectrum of the first pattern and a value of the excitation spectrum of the second pattern at the frequency of the second excitation radiation.

3. A security document according to claim 2, wherein at the frequency of the first excitation radiation 414 the value of the excitation spectrum of the first pattern 414 is substantially the same as the value of the excitation spectrum of the second pattern.

4. A security document according to claim 2, wherein the security pattern is adapted to be irradiated with an excitation radiation also from the direction of the second side.

5. A security document according to claim 4, wherein the security pattern has a third transmittivity coefficient for the second side and the first excitation radiation, the third transmittivity coefficient being selected in such a relation to the values of the excitation spectra of the first pattern and the second pattern that when the security pattern is irradiated from the direction of the second side at the first excitation radiation the second visible light dominates the first visible light.

6. A security document according to claim 5, wherein each one of the first transmittivity coefficient, the second transmittivity coefficient and the third transmittivity coefficient is in the range of 10 to 60%.

7. A security document according to claim 1, wherein the security pattern is substantially transparent with respect to the first visible light and the second visible light.

8. A security document according to claim 1, wherein the first visible light is red, and the second visible light is blue.

9. A security document according to claim 1, wherein the first excitation radiation has a frequency in the range 292 to 312 nm, and the second excitation radiation has a frequency in the range 355 to 375 nm.

10. A method of manufacturing a security document, the security document having a first side and a second side, the method comprising steps of:
forming a first pattern using a first colouring agent comprising first single fluorescent substance adapted to emit first visible light;
forming a second pattern using a second colouring agent comprising second single fluorescent substance adapted to emit second visible light different from the first visible light, the second pattern being located closer to the second side than the first pattern, the second pattern further being positioned such that the first pattern and the
second pattern overlap and the overlapping area defines a shape of a security pattern;
wherein both the first pattern and the second pattern have an excitation spectrum which has a substantially lower value at a frequency of a first excitation radiation than at a frequency of a second excitation radiation the excitation spectrum of the second pattern having a substantially higher value than the excitation spectrum of the first pattern at the frequency of the second excitation radiation, the security pattern having a first transmittivity coefficient for the first side and the first excitation radiation, and a second transmittivity coefficient for the first side and the second excitation radiation selected in such a relation to the values of the excitation spectra of the first pattern and the second pattern that when the security pattern is irradiated from the direction of the first side the first visible light dominates the second visible light at the first excitation radiation and the second visible light dominates the first visible light at the second excitation radiation.

11. A security document according to claim 3, wherein the security pattern is adapted to be irradiated with an excitation radiation also from the direction of the second side.

12. A security document according to claim 2, wherein the security pattern is substantially transparent with respect to the first visible light and the second visible light.

13. A security document according to claim 3, wherein the security pattern is substantially transparent with respect to the first visible light and the second visible light.

14. A security document according to claim 4, wherein the security pattern is substantially transparent with respect to the first visible light and the second visible light.

15. A security document claim 2, wherein the first visible light is red, and the second visible light is blue.

16. A security document claim 3, wherein the first visible light is red, and the second visible light is blue.

17. A security document claim 4, wherein the first visible light is red, and the second visible light is blue.

18. A security document according to claim 2, wherein the first excitation radiation has a frequency in the range 292 to 312 nm, and the second excitation radiation has a frequency in the range 355 to 375 nm.

19. A security document according to claim 3, wherein the first excitation radiation has a frequency in the range 292 to 312 nm, and the second excitation radiation has a frequency in the range 355 to 375 nm.

20. A security document according to claim 3, wherein the first excitation radiation has a frequency in the range 292 to 312 nm, and the second excitation radiation has a frequency in the range 355 to 375 nm.
